(19) United States
(12) Patent Application Publication
(10) Pub. No.: US 2025/0210765 A1
(43) Pub. Date: Jun. 26, 2025

(54) CYLINDRICAL BATTERY

(71) Applicant: Panasonic Energy Co., Ltd., Osaka (JP)

(72) Inventor: Masayoshi YOSHIDA, Osaka (JP)

(21) Appl. No.: 18/848,752

(22) PCT Filed: Mar. 20, 2023
(86) PCT No.: PCT/JP2023/010800

§ 371 Date: Sep. 19, 2024

(30) Foreign Application Priority Data
Mar. 30, 2022 (JP) 2022-054999

(51) Int. Cl. H01M 50/184; H01M 10/04; H01M 50/107; H01M 50/152; H01M 50/167; H01M 50/531

(52) U.S. Cl. CPC H01M 50/184; H01M 10/0431; H01M 50/107; H01M 50/152; H01M 50/167; H01M 50/531

(57) ABSTRACT

This cylindrical cell comprises: an electrode body in which a positive electrode and a negative electrode are wound with a separator therebetween; a cup-shaped outer can which accommodates the electrode body; a sealing body which is affixed by crimping to the opening portion of the outer can with a gasket therebetween; and a positive electrode lead which is joined to the inner surface of the sealing body. The inner surface of the sealing body has a protrusion which faces an edge in the width direction of the positive electrode lead and prevents the positive electrode lead rotating.

### DESCRIPTION

### Technical Field

The present disclosure relates to a cylindrical battery.

### Background Art

As a conventional cylindrical battery, there is a cylindrical battery described in Patent Literature 1. The cylindrical battery comprises an electrode assembly in which a positive electrode and a negative electrode are wound with a separator therebetween, a bottomed cylinder-shaped external can that accommodates the electrode assembly, and a sealing assembly that is fixed by crimping at an opening portion of the external can via a gasket. In the cylindrical battery, another end portion of a positive electrode lead with one end portion joined to the positive electrode of the electrode assembly is joined to an inner surface of the sealing assembly and a top surface of the sealing assembly serves as a positive electrode terminal.

### CITATION LIST

### Patent Literature

PATENT LITERATURE 1: Japanese Unexamined Patent Application Publication No. Hei 6-187968

### SUMMARY

When an excessive load in a rotational direction is exerted on a joint portion between a positive electrode lead and a sealing assembly due to an impact as a result of dropping of a cylindrical battery or the like, the joint portion could break. Therefore, it is an advantage of the present disclosure to provide a cylindrical battery in which an excessive load in a rotational direction is less likely to be exerted on the joint portion between the lead and the sealing assembly to thus suppress breaking of the joint portion.

To solve the aforementioned problem, the cylindrical battery according to the present disclosure comprises: an electrode assembly in which a positive electrode and a negative electrode are wound with a separator therebetween: a bottomed cylinder-shaped external can that accommodates the electrode assembly: a sealing assembly that is fixed by crimping at an opening portion of the external can via a gasket; and a lead joined to an inner surface of the sealing assembly, in which the inner surface of the sealing assembly includes a projection opposing an end portion in a width direction of the lead, the projection being configured to prevent the lead from rotating.

According to the cylindrical battery of the present disclosure, since an excessive load in a rotational direction is less likely to be exerted on the joint portion between the lead and the sealing assembly, breaking of the joint portion is suppressed.

### BRIEF DESCRIPTION OF DRAWINGS

FIG. 1 is a sectional view in an axial direction of a cylindrical battery according to one embodiment of the present disclosure.

FIG. 2 is a perspective view of an electrode assembly of the aforementioned cylindrical battery.

FIG. 3A is a plan view of a center portion of a terminal plate of the aforementioned cylindrical battery as viewed from a lower side in the axial direction.

FIG. 3B is a sectional view of the center portion of the terminal plate in the axial direction.

FIG. 4 is a schematic plan view of the center portion of the aforementioned terminal plate to which a positive electrode lead is joined as viewed from the lower side.

FIG. 5 is an enlarged plan view of the surrounding of a joint portion of the positive electrode lead of FIG. 4.

FIG. 6 is an enlarged plan view for explaining the relation in arrangement and position between a projection and the positive electrode lead of the aforementioned cylindrical battery.

FIG. 7 is a schematic plan view of a cylindrical battery of a comparative example corresponding to FIG. 4.

FIG. 8 is an enlarged plan view of a cylindrical battery of a modification corresponding to FIG. 6.

### DESCRIPTION OF EMBODIMENTS

Hereinafter, with reference to the drawings, an embodiment of a cylindrical battery according to the present disclosure will be described in detail. Note that the cylindrical battery of the present disclosure may be a primary battery or a secondary battery. Further, the cylindrical battery of the present disclosure may be a battery using an aqueous electrolyte or a battery using a non-aqueous electrolyte. Hereinafter, as a cylindrical battery 10 as one embodiment, a non-aqueous electrolyte secondary battery (lithium ion battery) using a non-aqueous electrolyte will be illustrated, but the cylindrical battery of the present disclosure is not limited thereto.

It has been initially expected that the characteristics of the embodiment and modification described below are appropriately combined to form a new embodiment. In the embodiment below, the same components in the drawings will be assigned the same reference signs and the overlapping descriptions will be omitted. Further, a plurality of drawings includes schematic illustrations, and among the different drawings, the dimensional ratios in length, width, height, and the like of each member do not necessarily correspond. In the present specification, the side of a sealing assembly 17 in the axial direction (height direction) of the cylindrical battery 10 is assumed to be “up” and the side of a bottom portion 55 of an external can 16 in the axial direction is assumed to be “down.” Further, of the constituent elements described below, the constituent elements that are not recited in independent claim showing the most generic concept are optional constituent elements, and not essential constituent elements.

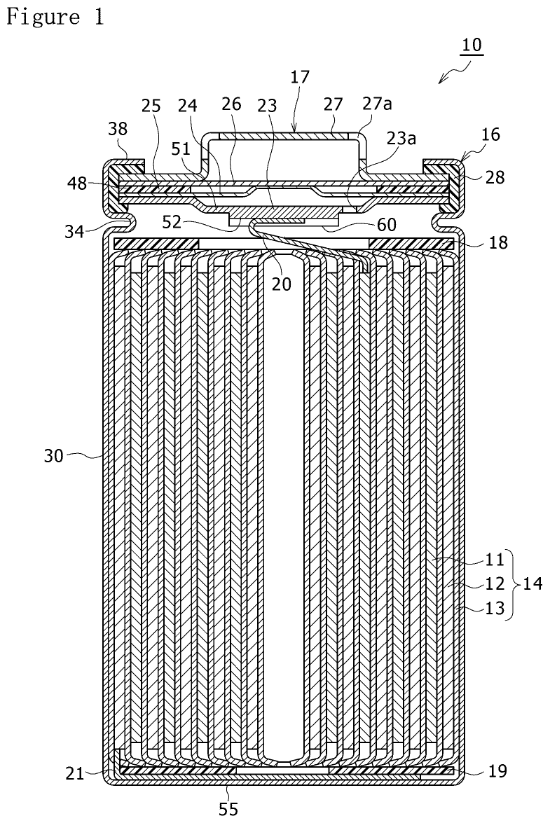

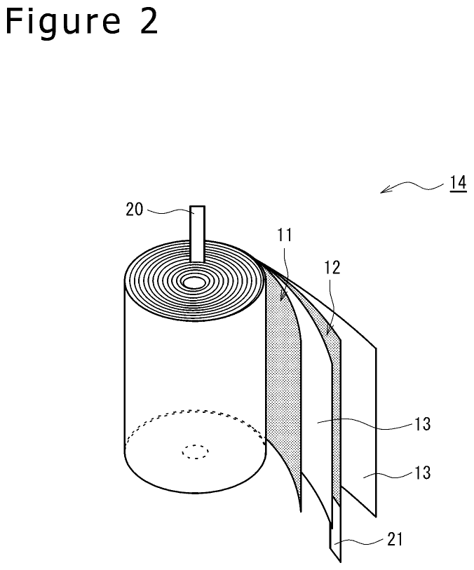

FIG. 1 is a sectional view in the axial direction of the cylindrical battery 10 according to one embodiment of the present disclosure, and FIG. 2 is a perspective view of an electrode assembly 14 of the cylindrical battery 10. As shown in FIG. 1, the cylindrical battery 10 comprises the wound-type electrode assembly 14, a non-aqueous electrolyte (not shown), a bottomed cylindrical shaped metal external can 16 that accommodates the electrode assembly 14 and the non-aqueous electrolyte, and the sealing assembly 17 that seals an opening portion of the external can 16. As shown in FIG. 2, the electrode assembly 14 has a wound structure in which a long positive electrode 11 and a long negative electrode 12 are wound with two long separators 13.

The negative electrode 12 is formed in dimensions slightly larger than the positive electrode 11 in order to prevent lithium deposition. In other words, the negative electrode 12 is formed longer in the longitudinal direction and in the width direction (lateral direction) than the positive electrode 11. Further, the two separators 13 are formed in dimensions slightly larger than at least the positive electrode 11 and are disposed, for example, so as to sandwich the positive electrode 11. The negative electrode 12 may form a winding-start end of the electrode assembly 14. However, in general, the separator 13 extends beyond an end on a winding-start side of the negative electrode 12, and an end on a winding-start side of the separator 13 becomes the winding-start end of the electrode assembly 14.

The non-aqueous electrolyte includes a non-aqueous solvent and electrolyte salt dissolved in the non-aqueous solvent. For the non-aqueous solvent, for example, esters, ethers, nitriles, amides, and any mixed solvent of two or more thereof may be used. The non-aqueous solvent may contain a halogen-substituted product formed by replacing at least a portion of a hydrogen atom of any of these solvents with a halogen atom such as fluorine. Note that the non-aqueous electrolyte is not limited to a liquid electrolyte and may be a solid electrolyte using a gel polymer or the like. For the electrolyte salt, lithium salt such as LiPF₆ is used.

The positive electrode 11 includes a positive electrode core and positive electrode mixture layers formed on both sides of the positive electrode core. For the positive electrode core, metal foil stable in a potential range of the positive electrode 11, such as aluminum and an aluminum alloy, a film with the metal disposed on the surface layer, and the like can be used. The positive electrode mixture layers include a positive electrode active material, a conductive agent, and a binding agent. The positive electrode 11 can be produced, for example, such that the positive electrode core is coated with positive electrode mixture slurry including the positive electrode active material, the conductive agent, the binding agent, and the like, and the coating is dried and is then compressed so that the positive electrode mixture layers are formed on both sides of the positive electrode core.

The positive electrode active material includes a lithium-containing metal complex oxide as a main component. Examples of the metal element contained in the lithium-containing metal complex oxide may include Ni, Co, Mn, Al, B, Mg, Ti, V, Cr, Fe, Cu, Zn, Ga, Sr, Zr, Nb, In, Sn, Ta, and W. A preferable example of the lithium-containing metal complex oxide is a complex oxide containing at least one of the group consisting of Ni, Co, Mn, and Al.

Examples of the conductive agent included in the positive electrode mixture layer may include a carbon material, such as carbon black, acetylene black, ketjen black, and graphite. Examples of the binding agent included in the positive electrode mixture layer may include a fluorocarbon resin, such as polytetrafluoroethylene (PTFE) and polyvinylidene fluoride (PVdF), polyacrylonitrile (PAN), a polyimide resin, an acrylic resin, and a polyolefin resin. These resins and carboxymethylcellulose (CMC) or a cellulose derivative such as carboxymethylcellulose salt, a polyethylene oxide (PEO), and the like may be concurrently used.

The negative electrode 12 includes a negative electrode core and negative electrode mixture layers formed on both sides of the negative electrode core. For the negative electrode core, metal foil stable in a potential range of the negative electrode 12, such as copper and a copper alloy, a film with the metal disposed on the surface layer, and the like can be used. The negative electrode mixture layers include a negative electrode active material and a binding agent. The negative electrode 12 can be produced, for example, such that the negative electrode core is coated with negative electrode mixture slurry including the negative electrode active material, the binding agent, and the like, and the coating is dried and is then compressed so that the negative electrode mixture layers are formed on both sides of the negative electrode core.

For the negative electrode active material, a carbon material that reversibly occludes and releases lithium ions is generally used. The preferable carbon material is graphite, such as natural graphite such as flake graphite, massive graphite, and amorphous graphite, artificial graphite such as massive artificial graphite and graphitized mesophase carbon microbeads. The negative electrode mixture layer may include, as the negative electrode active material, a Si material-containing silicon (Si). In addition, for the negative electrode active material, metal to be alloyed with lithium other than Si, an alloy containing the metal, a compound containing the metal, and the like may be used.

For the binding agent included in the negative electrode mixture layer, a fluorocarbon resin, PAN, a polyimide resin, an acrylic resin, a polyolefin resin, and the like may be used, as with the case of the positive electrode 11, but styrene butadiene rubber (SBR) or a modified product thereof is preferably used. For the negative electrode mixture layer, for example, in addition to SBR or the like, CMC or CMC salt, polyacrylic acid (PAA) or polyacrylic acid salt, and polyvinyl alcohol may be included.

For the separator 13, a porous sheet having ion permeability and insulating property is used. Specific examples of the porous sheet may include a microporous thin film, cloth, and a nonwoven fabric. As a material of the separator 13, a polyolefin resin such as polyethylene and polypropylene, cellulose, and the like are preferable. The separator 13 may be in either a single layer structure or a stacked layer structure. On the surface of the separator 13, a heat-resistant layer and the like may be formed.

As shown in FIG. 1, a positive electrode lead 20 is joined to the positive electrode 11 and a negative electrode lead 21 is joined to a winding-end side in the longitudinal direction of the negative electrode 12. The cylindrical battery 10 includes an insulating plate 18 on an upper side of the electrode assembly 14 and an insulating plate 19 on a lower side of the electrode assembly 14. The positive electrode lead 20 passes through a through-hole of the insulating plate 18 and extends to the sealing assembly 17 side, and the negative electrode lead 21 passes an outer side of the insulating plate 19 and extends to the bottom portion 55 side of the external can 16. The positive electrode lead 20 is joined to an underside of a terminal plate 23 of the sealing assembly 17 by laser welding. The underside of the terminal plate 23 is an example of an inner surface of the sealing assembly 17. A terminal cap 27 forming a top plate of the sealing assembly 17 is electrically connected to the terminal plate 23 and the terminal cap 27 serves as a positive electrode terminal. Further, the negative electrode lead 21 is joined to an inner surface of the bottom portion 55 of the metal external can 16 by welding or the like and the external can 16 serves as a negative electrode terminal.

In the example shown in FIG. 1 and FIG. 2, the positive electrode lead 20 is electrically connected to a middle section such as a center portion in a winding direction of the positive electrode core, and the negative electrode lead 21 is electrically connected to an end portion on a winding-end side in a winding direction of the negative electrode core. However, the negative electrode lead may be electrically connected to an end portion on a winding-start side in the winding direction of the negative electrode core. Alternatively, the electrode assembly may include two negative electrode leads, with one negative electrode lead electrically connected to the end portion on the winding-start side in the winding direction of the negative electrode core and with the other negative electrode lead electrically connected to the end portion on the winding-end side in the winding direction of the negative electrode core. Alternatively, the negative electrode and the external can may be electrically connected by bringing the end portion on the winding-end side in the winding direction of the negative electrode core into contact with an inner surface of the external can. Alternatively, the negative electrode lead may be electrically connected to the end portion on the winding-start side of the negative electrode core, with the end portion on the winding-end side in the winding direction of the negative electrode core contacted with the inner surface of the external can.

The cylindrical battery 10 further comprises a resin gasket 28 disposed between the external can 16 and the sealing assembly 17. The sealing assembly 17 is fixed by crimping at the opening portion of the external can 16 via the gasket 28. In this manner, an interior space of the cylindrical battery 10 is sealed. The gasket 28 is sandwiched between the external can 16 and the sealing assembly 17 and insulates the sealing assembly 17 from the external can 16. The gasket 28 has a function as a sealing material to maintain the air tightness inside the battery and a function as an insulating material to insulate between the external can 16 and the sealing assembly 17.

The external can 16 accommodates the electrode assembly 14 and the non-aqueous electrolyte and includes a shoulder portion 38, a grooved portion 34, a cylinder-shaped portion 30, and the bottom portion 55. The grooved portion 34 can be formed by, for example, spinning a portion of a side wall of the external can 16 radially inward so as to annularly dent the portion radially inward. The shoulder portion 38 is formed such that in fixing the sealing assembly 17 to the external can 16 by crimping, an upper end portion of the external can 16 is inwardly folded toward a circumferential edge portion 48 of the sealing assembly 17.

The sealing assembly 17 has a structure in which the terminal plate 23, a lower vent member 24, an insulating member 25, an upper vent member 26, and the terminal cap 27 are stacked in this order from the electrode assembly 14 side. The members forming the sealing assembly 17 have, for example, a disc-shape or a ring-shape, and are electrically connected to one another, except for the insulating member 25. The terminal plate 23 includes at least one through-hole 23a. Further, the lower vent member 24 and the upper vent member 26 are connected at the respective center portions and the insulating member 25 is interposed between the respective circumferential edges.

When the cylindrical battery 10 extremely generates heat to increase the internal pressure of the cylindrical battery 10, the lower vent member 24 is deformed so as to push up the upper vent member 26 toward the terminal cap 27 and breaks, so that the current path between the lower vent member 24 and the upper vent member 26 is disrupted. When the internal pressure further increases, the upper vent member 26 breaks, thereby discharging gas through a through-hole 27a of the terminal cap 27. By discharging the gas, the cylindrical battery 10 can be prevented from rupturing due to an excessive increase in the internal pressure of the cylindrical battery 10, thereby being able to improve the safety of the cylindrical battery 10.

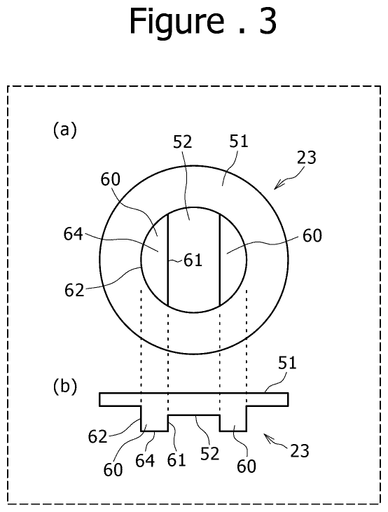

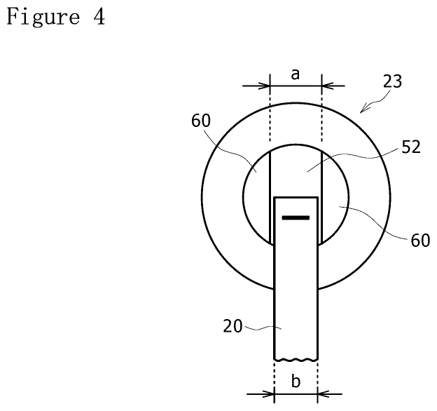

FIG. 3A is a plan view of a center portion of the terminal plate 23 as viewed from a lower side in the axial direction, and FIG. 3B is a sectional view of the center portion of the terminal plate 23 in the axial direction. Further, FIG. 4 is a schematic plan view of the center portion of the terminal plate 23 to which the positive electrode lead 20 is joined as viewed from the lower side. As shown in FIGS. 3A and 3B, the terminal plate 23 includes a disc-shaped first disc portion 51, a disc-shaped second disc portion 52 projecting to the lower side in the axial direction from a center portion of the first disc portion 51, and two identical projections 60 projecting to the lower side in the axial direction from the second disc portion 52 and facing each other with an interval in the radial direction. The first disc portion 51 and the second disc portion 52 may be formed as a single disc portion.

The projections 60 each include a flat inner side surface 61, an arc-shaped outer circumferential surface 62, and a distal end surface 64 expanding in a direction orthogonal to the axial direction. The two inner side surfaces 61 are disposed in parallel so as to face each other. As shown in FIG. 4, a distance a between the two inner side surfaces 61 is longer than a width b of the positive electrode lead 20. The positive electrode lead 20 is joined to the second disc portion 52 and a joint portion between the positive electrode lead 20 and the sealing assembly 17 is positioned between the two projections 60.

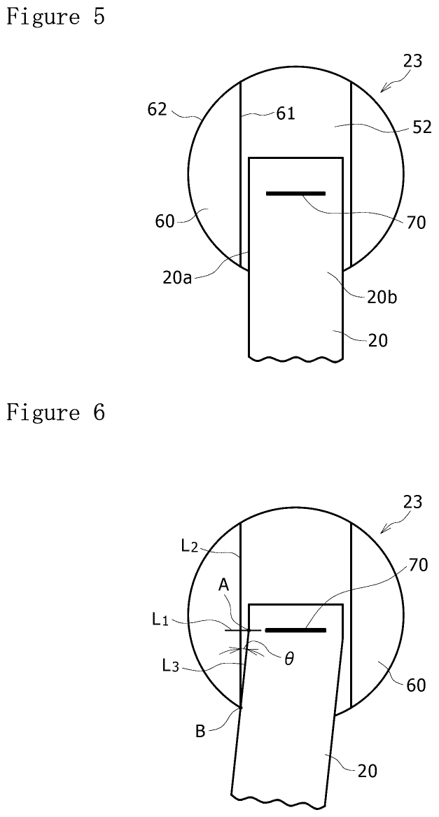

FIG. 5 is an enlarged plan view of the surrounding of the joint portion of the positive electrode lead 20 of FIG. 4. As shown in FIG. 5, the inner side surface 61 of the projection 60 forms an opposing face opposing an end face 20a in a width direction of the positive electrode lead 20. The positive electrode lead 20 is preferably joined to the second disc portion 52 such that the end face 20a in the width direction is substantially parallel to the inner side surface 61. Further, the positive electrode lead 20 is preferably joined to a center between the projections 60.

As shown in FIG. 5, the second disc portion 52 and the positive electrode lead 20 are joined such that an underside 20b of the positive electrode lead 20 is irradiated with laser lights while scanning the positive electrode lead 20 for a predetermined length in the width direction and the positive electrode lead 20 is joined to the second disc portion 52 by one linear joint portion 70. The linear joint portion 70 extends in the width direction and is provided at a center portion in the width direction of the positive electrode lead 20. With the use of such a method, the joining can be performed by scanning with laser lights only for a predetermined distance, thereby achieving an excellent productivity of the cylindrical battery 10. Note that the joining of the positive electrode lead to the inner surface of the sealing assembly may be performed by a method other than laser welding, for example, ultrasonic welding.

FIG. 6 is an enlarged plan view for explaining the relation in arrangement and position between the projection 60 and the positive electrode lead 20. As shown in FIG. 6, a point where a straight line L1 passing a center of the joint portion 70 and extending in the width direction of the positive electrode lead 20 crosses an edge in the width direction of the positive electrode lead 20 on a side of one projection (hereinafter, referred to as a first projection) 60 is assumed to be a point A, and a point where the positive electrode lead 20 contacts the first projection 60 when a portion on a side of the electrode assembly 14 of the positive electrode lead 20 is rotated about the point A to the side of the first projection 60 is assumed to be a point B. Further, a line passing the point B and parallel to an extending direction of the positive electrode lead 20 before rotation takes place is assumed to be a lead parallel line L2. At this time, an angle θ formed by a line L3 passing the point A and the point B and the lead parallel line L2 is less than or equal to 20 degrees.

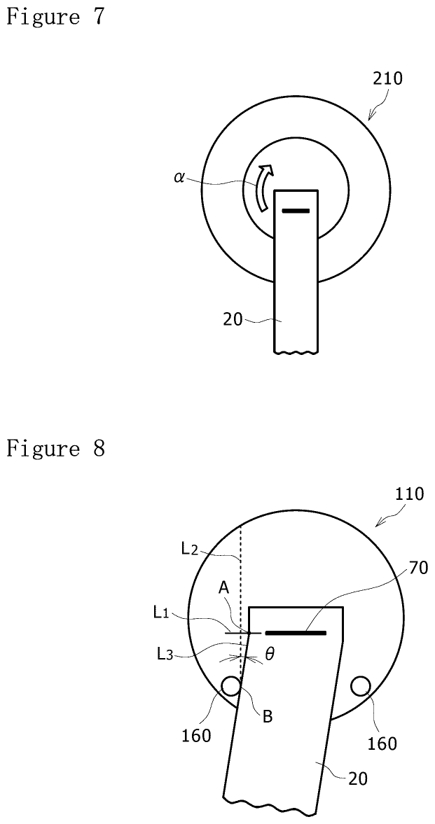

FIG. 7 is a schematic plan view of a cylindrical battery 210 of a comparative example corresponding to FIG. 4. As shown in FIG. 7, in a case without having the aforementioned projection 60, when an excessive load in a rotational direction denoted by an arrow α, which is parallel to a joint surface of the positive electrode lead 20, is exerted on the joint surface due to an impact as a result of dropping of the cylindrical battery 210 or the like, the rotation of the positive electrode lead 20 cannot be prevented, which could break the joint portion 70.

By contrast, according to the present cylindrical battery 10, since the projections 60 are present on both sides in the width direction of the positive electrode lead 20, when the positive electrode lead 20 rotates at a predetermined angle, the positive electrode lead 20 contacts the projection 60, thereby being able to prevent further rotation of the positive electrode lead 20. Therefore, since the rotating range of the positive electrode lead 20 can be restricted, breaking of the joint portion 70 of the positive electrode lead 20 to disengage the positive electrode lead 20 can be effectively suppressed. The projections 60 are provided in order to prevent the positive electrode lead 20 from rotating at an angle greater than a predetermined angle. The inventors of the present application have confirmed in the rotation test that when the angle θ formed by the aforementioned L2 and L3 is less than or equal to 20 degrees, the positive electrode lead 20 is not disengaged. Therefore, according to the present cylindrical battery 10, since the angle θ formed by the aforementioned L2 and L3 is less than or equal to 20 degrees, the positive electrode lead 20 can be surely prevented from being disengaged.

Note that the present disclosure is not limited to the aforementioned embodiment and a modification thereof, and various improvements and changes are available within the matters described in the scope of claims of the present application and the equivalents. For example, in the aforementioned embodiment, the case in which in the projection 60, the opposing face opposing the end face in the width direction of the positive electrode lead 20 is formed with the flat inner side surface 61 has been described. However, the projection may have any shape that can prevent rotation of the positive electrode lead. Further, in the projection, the surface opposing the end face in the width direction of the positive electrode lead may be in any shape, without being flat.

FIG. 8 is an enlarged plan view of a cylindrical battery 110 of a modification corresponding to FIG. 6. As shown in FIG. 8, two projections 160 projecting to the lower side in the axial direction may have a columnar shape. Note that also in this case, as described above, when the angle θ formed by the line L3 passing the point A and the point B and the lead parallel line (denoted by a dotted line in FIG. 8) L2 is less than or equal to 20 degrees, the positive electrode lead 20 can be surely prevented from being disengaged.

In the aforementioned embodiment, the case in which the sealing assembly 17 has the structure in which the terminal plate 23, the lower vent member 24, the insulating member 25, the upper vent member 26, and the terminal cap 27 are stacked in this order from the electrode assembly 14 side has been described. However, the sealing assembly may have any other structure, and may have a structure, for example, in which the terminal plate, an annular insulating plate, and the vent member are stacked in this order from the electrode assembly side or which only includes the vent member. Further, the case in which the positive electrode lead 20 joined to the positive electrode 11 is joined to the inner surface of the sealing assembly 17 and the negative electrode 12 is electrically connected to the external can 16 has been described. However, the negative electrode lead joined to the negative electrode may be joined to the inner surface of the sealing assembly and the positive electrode may be electrically connected to the external can.

### REFERENCE SIGNS LIST

10, 110 Cylindrical battery, 11 Positive electrode, 12 Negative electrode, 13 Separator, 14 Electrode assembly, 16 External can, 17 Sealing assembly, 18, 19 Insulating plate, 20 Positive electrode lead, 20a End face in width direction of positive electrode lead, 20b Underside of positive electrode lead, 21 Negative electrode lead, 23 Terminal plate, 24 Lower vent member, 25 Insulating member, 26 Upper vent member, 27 Terminal cap, 28 Gasket, 30 Cylinder-shaped portion, 34 Grooved portion, 38 Shoulder portion, 48 Circumferential edge portion, 51 First disc portion, 52 Second disc portion, 55 Bottom portion, 60, 160 Projection, 61 Inner side surface of projection, 62 Outer circumferential surface of projection, 64 Distal end surface of projection, 70 Joint portion

1. A cylindrical battery comprising:
an electrode assembly in which a positive electrode and a negative electrode are wound with a separator therebetween;
a bottomed cylinder-shaped external can that accommodates the electrode assembly;
a sealing assembly that is fixed by crimping at an opening portion of the external can via a gasket; and
a lead joined to an inner surface of the sealing assembly, wherein
the inner surface of the sealing assembly includes a projection opposing an end portion in a width direction of the lead, the projection being configured to prevent the lead from rotating.

2. The cylindrical battery according to claim 1, wherein
the lead is joined to the inner surface by a joint portion, and
when a point where a straight line passing a center of the joint portion and extending in the width direction of the lead crosses an edge in the width direction of the lead on a side of the projection is assumed to be a point A. a point where the lead contacts the projection when a portion on a side of the electrode assembly in the lead is rotated about the point A to the side of the projection is assumed to be a point B, and a line passing the point B and parallel to an extending direction of the lead before rotation takes place is assumed to be a lead parallel line, an angle θ formed by a line passing the point A and the point B and the lead parallel line is less than or equal to 20 degrees.

3. The cylindrical battery according to claim 1, wherein in the projection, an opposing face opposing an end face in the width direction of the lead is flat.
